(19) United States
(12) Patent Application Publication
(10) Pub. No.: US 2008/0276857 A1
(43) Pub. Date: Nov. 13, 2008

(54) Indicator With Screen Lit By Subdued And Warning Lights

(75) Inventor: Joel Fournier, Cergy (FR)

Correspondence Address: FOLEY AND LARDNER LLP;SUITE 500, 3000 K STREET NW, WASHINGTON, DC, 20007, US

(73) Assignee: Johnson Controls Technology Company, Holland, MI (US)

(21) Appl. No.: 11/630,552

(22) PCT Filed: Jun. 16, 2005
(86) PCT No.: PCT/FR2005/001506

§ 371 Date: Apr. 11, 2008

(30) Foreign Application Priority Data
Jun. 23, 2004 (FR) 0406827

(51) Int. Cl. F21S 10/00

(52) U.S. Cl. 116/202

(57) ABSTRACT

The screen (3) is in a light box (6). Lighting means (5, 11) are arranged to light the screen (3) with a subdued light and a warning light. The subdued lighting means (5) are placed in the light box (6) and the warning lighting means (11) are remotely located outside the light box (6), to light the screen (3) via a light duct (8).

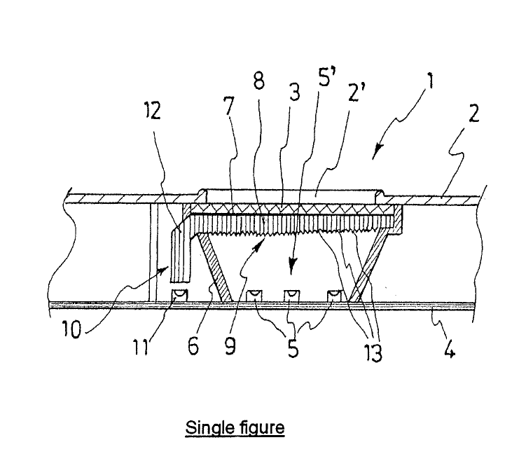

The invention applies to motor vehicle dashboards.

The invention relates to an indicator with a display screen lit with subdued and warning lights.

Dashboards, particularly those of motor vehicles, more and more often comprise a display screen, for example a screen of the LCD (Liquid Crystal Display) type, on which information texts or icons for the driver appear. This screen is backlit by lighting sources, for example light-emitting diodes (LEDs), distributed in a matrix.

In the conventional operating mode, the screen is lit by LEDs providing a subdued light, for example, white, blue or green. However, for certain information, such as warning information, it is desirable that the lighting changes colour and becomes, for example, orange or red, depending on the degree of warning.

In order to allow such changes of lighting colour, various devices are currently proposed. It is possible to use a screen of the TFT (Thin Film Transistor) type. These screens are nevertheless very costly. Also frequently used are multicolour LEDs, for example with three colours—white, orange and red—whose colour is made to change depending on the nature of the message displayed on the screen. But these LEDs are expensive, for instance ten times the price of a single-colour LED for a three-colour LED.

It has been proposed to place at the rear of the LCD screen a matrix of triplets of single-colour LEDs of different colours. White LEDs are lit to obtain a subdued light and they are switched off to light up orange LEDs or red LEDs in the event of a warning. However, the LEDs are attached directly to a printed circuit board situated at the rear of the screen, which causes a double bulkiness problem. First of all, a triplet of LEDs occupying a much greater area than a single LED, the number of LEDs of one and the same colour must be greatly reduced, which does not allow a satisfactory lighting for this colour. Then, around each LED, it is necessary to arrange a cooling surface on the printed circuit board; this obligation aggravates the abovementioned bulkiness problem, its effects being all the more regrettable because of the presence of triplets of LEDs, only one of which is used at a given moment. The number of LEDs of a particular colour must be greatly reduced and the lighting is insufficient.

The invention aims to palliate these disadvantages and to propose a device for lighting, via the rear of a display screen, an indicator that is uniformly lit, with the possibility of changing the display colour, with less bulkiness and at less cost.

Accordingly, the invention relates to an indicator with a display screen in a light box with lighting means arranged to light the screen with a subdued light and a warning light, characterized in that subdued lighting means are placed in the light box and warning lighting means are remotely located outside the light box, to light the screen via a light duct.

Thanks to the invention, the subdued lighting means placed in the light box may comprise individual sources in large quantity, installed on the zone of the printed circuit board facing the screen, the warning lighting being able to be supplied by sources in small quantity. Thus, an optimal screen lighting may be obtained with very little bulk.

Preferably, the light duct is transparent and partly extends into the light box between the subdued lighting means and the screen.

Advantageously, in this case, the light duct comprises means shaped to break up the light originating from the remotely located warning lighting means towards the display screen.

Again preferably, the display screen is a screen of the LCD (Liquid Crystal Display) type.

Still preferably, the lighting means comprise light-emitting diodes (LEDs).

The invention applies particularly to an indicator for a dashboard of a motor vehicle or of any other means of locomotion. But the applicant does not intend to limit the scope of its rights to this application.

The invention will be better understood with the aid of the following description of the preferred embodiment of the indicator of the invention, with reference to the appended drawing, in which the single FIGURE represents a view in section of the indicator of the invention.

The indicator 1 described here is a dashboard indicator of a motor vehicle, arranged to display information texts or icons for the driver, such as information on the speed of the vehicle, the quantity of fuel remaining in the tank, the route to be followed, etc.

The façade of the dashboard 2 comprises a recess 2′ for viewing a display screen 3 of the indicator, that is, in this instance, a screen of the LCD type, flat and rectangular in shape. The recess 2′ here is covered by a protective pane. The LCD screen 3 is attached just behind the façade of the dashboard 2, the major portion of its front surface extending beneath the protective pane and therefore being visible to the driver. The LCD screen 3 is arranged to display texts or icons, controlled by the printed circuit 4, in a manner known to those skilled in the art, which will not be described in detail.

In what follows, it will be considered that the front is the side from which the driver, or more generally the observer of the indicator, will look at the latter.

The printed circuit board 4 extends parallel to the LCD screen 3 and at the rear of the latter. On the printed circuit board 4, in line with the LCD screen 3, in a light box 6, subdued lighting sources 5, in this instance light-emitting diodes (LEDs) 5 are mechanically and electrically attached. These subdued LEDs 5 are here white in colour. Their function is to backlight the LCD screen 3 in a mode qualified as “normal”, that is to say for the display of conventional or basic information. The subdued LEDs 5 are distributed in a matrix 5′ situated in line with the LCD screen 3, here comprising three parallel rows of LEDs 5.

The partition forming the light box 6 extends around the matrix 5′ between the LCD screen 3 and the printed circuit board 4. Its cross section here decreases rearwards, from the LCD screen 3 towards the printed circuit board 4. An equalization filter 7 is attached to the rear face of the LCD screen 3; its function is to even out the light backlighting the screen 3, so that the latter lights the screen evenly, even though the light sources are discrete sources. The equalization filter 7 is of a shape, viewed from the rear, that is identical to that of the screen 3, therefore of rectangular shape here, and is inside the light box 6.

Attached to the rear face of the filter 7 is a transparent light duct 8 that is L-shaped when seen in section along either its width or its length, here its width. The front face of the portion 9 forming the large bar of the L hugs the rear face of the filter 7. It is along the width of this portion 9 that the section of the single FIGURE is made. Its thickness increases from the end furthest from the portion 10 forming the small bar of the L to the end close to this portion 10.

The portion 9 forming the large bar of the L and the portion 10 forming the small bar of the L will hereinafter be called large portion 9 and small portion 10 respectively. The large portion 9 generally forms a rectangular plate hugging the shape of the equalization filter 7 and extending into the light box 6, while the small portion 10 generally forms a rectangular plate whose length is that of the large portion 9 and extends outside the light box 6.

The small portion 10 extends perpendicularly to the large portion 9, hence perpendicularly to the printed circuit board 4. In line with this small portion 10, at the rear, that is to say on its free side, warning light sources 11, in this instance warning LEDs 11, are mechanically and electrically attached to the printed circuit board 4. These warning LEDs 11 are placed in a remote manner relative to the zone situated in line with the LCD screen 3, outside the light box 6, and the light duct 8 is arranged so that its small portion 10 is situated in line with these warning LEDs 11.

Between its small portion 10 and its large portion 9, the light duct 8 comprises a portion 12 with inclined faces providing the junction between the two portions 9, 10. The faces of this inclined portion 12 are here inclined at 45° relative to the perpendicular faces of the portions 9, 10 forming the bars of the L. The function of this inclined portion 12 is to direct the light originating from the warning LEDs 11 from the small portion 10 to the large portion 9.

The warning LEDs 11 here are red or orange in colour, placed in a single row parallel with the three rows of the subdued LEDs 5. Along this row, there is alternation between a red warning LED 11 and an orange warning LED 11.

The rear face of the large portion 9 of the light duct 8 comprises a structure 13 whose function is to break up the light, particularly the light originating from inside the duct 8, especially the light originating from the warning LEDs 11 via the small portion 10 via the inclined portion 12. This structure 13 here is a studded structure 13.

The operation of the indicator 1 will now be explained in greater detail.

In “normal” operating mode, that is when the information that appears on the LCD screen 3 is conventional information that is not particularly worthy of emphasis, the LCD screen 3 is lit by the white subdued LEDs 5. The light that they emit is directed in the light box 6 towards the rear face of the large portion 9 of the light duct 8; this duct 8 is transparent, so the light passes through it, is equalized by the equalization filter 7 and backlights the LCD screen 3.

In “warning” operating mode, that is when the information that appears on the LCD screen 3 is of particular importance that is worthy of emphasis, the LCD screen 3 is lit by the warning LEDs 11. The information qualified as “warning” is for example of the type that warns the driver of an excessive speed, of insufficient fuel in the tank, of a failure of a member of the vehicle, etc.

The light emitted by the warning LEDs 11 enters the light duct 8 via the free end of its small portion 10 placed close to the warning LEDs 11; it is conducted in this portion 10, is reflected in the inclined portion 12 towards the large portion 9, in which it is propagated; there it is reflected and broken up on the studs 13 towards the equalization filter 7 where it is equalized in order to backlight the LCD screen 3, in an even manner.

Because of the reducing thickness of the large portion 9 the further it is from the small portion 10, that is to say in the direction of propagation of the light originating from the small portion 10, the light is well reflected and broken up towards the equalization filter 7.

It can be noted that the light originating from the warning LEDs 11 may be broken up by the studs 13. It could also be broken up, for example, by grooves extending on the large portion 9 of the light duct 8 across the direction of propagation of the light originating from its small portion 10.

The orange or red coloured warning LEDs 11 are lit depending on the degree of the warning. When the warning LEDs 11 are lit, it is possible either to switch off the subdued LEDs 5 or to leave them on. The latter solution is preferable because then the subdued LEDs 5 provide a better luminosity, their power being able to be reduced if necessary, while the warning LEDs 11 provide the colouration of the illumination lighting, and hence the display lighting, of the LCD screen 3; in this situation, it is possible to minimize the number of warning LEDs 11 of a particular colour and all the more evidently solve the problem posed hereinabove.

It is the printed circuit board 4 that provides the sequencing and coordination of the lighting of the various light sources 5, 11 according to the nature of the message that has to appear on the LCD screen 3.

The invention has been described with reference to warning light sources that are remotely located and placed in a row, with alternation of LEDs of two different colours. It goes without saying that a multitude of other configurations is possible; some will be enumerated as examples.

It may be possible to have only one colour of warning LED, all aligned in a single row. There may be two parallel rows of warning LEDs, for example a row of one colour and a row of another colour, or two rows in which the two colours alternate, the two rows being offset from one another with respect to this alternation. A single row of two-colour LEDs can be provided, whose colour is changed according to the nature of the warning. More than two colours may be provided for the warning LEDs.

The invention has been described with reference to a rectangular LCD screen, but it goes without saying that it could be square, round, oval, etc. The other members of the indicator are then adapted to this screen.

In addition, the light duct has been described as having an L-shaped sectional view with a portion with inclined faces, but it goes without saying that the portion with inclined faces could be replaced by a curved portion, that the section could be other than L-shaped, etc. What is essential is that the duct performs its function of conducting the light from the remotely located lighting sources to the display screen.

1-7. (canceled)

8. An indicator, comprising:
a display screen in a light box with light sources arranged to illuminate the screen with a subdued light and a warning light;
wherein the subdued light is placed in the light box and the warning light is remotely located outside the light box, to illuminate the screen via a light duct.

9. The indicator of claim 8, wherein the light duct is transparent and a portion extends into the light box between the subdued light and the screen.

10. The indicator of claim 9, wherein the light duct comprises a surface shaped to break up the light originating from the remotely located warning light towards the display screen.

11. The indicator of claim 10, wherein surface shaped to break up light comprises a structure arranged on the surface, on the portion of the light duct extending into the light box.

12. The indicator of claim 8, wherein the display screen is a liquid crystal display.

13. The indicator of claim 8, wherein the light sources are light-emitting diodes.

14. The indicator of claim 8, wherein the indicator is for a motor vehicle dashboard.

15. An indicator assembly for a vehicle, comprising:
a light box;
a display screen coupled to the light box;
a first light source included in the light box to selectively provide light to the screen; and
a second light source configured to provide lighting to a light duct thereby illuminating the display screen.

16. The indicator of claim 15, wherein the light duct is transparent and positioned between the light box and first light source.

17. The indicator of claim 16, wherein the light duct comprises a jagged surface shaped to distort light originating from the second light source towards the display screen.

18. The indicator of claim 15, wherein the display screen is a liquid crystal display.

19. The indicator of claim 15, wherein the light sources are light-emitting diodes.

20. The indicator of claim 15, wherein the second light source is configured to be brighter than the first light source.

21. An indicator assembly for a vehicle with triaged lighting, comprising:
a housing;
a display screen coupled to the housing;
a light box coupled to the housing;
a first light source included in the light box to selectively provide light to the screen;
a light pipe positioned between the light box and first light source;
a second light source configured to provide lighting to the light pipe; and
a control circuit configured to receive:
a first signal associated with a first vehicle characteristic; and
a second signal associated with a second vehicle characteristic;
wherein the control circuit is configured to illuminate the first light source upon receiving the first signal and illuminate the second light source upon receiving the second signal;
wherein the light pipe is configured to be located in front of the first light source.

22. The indicator of claim 21, wherein the second vehicle characteristic has a greater priority of display than the first vehicle characteristic.

23. The indicator of claim 22, wherein lighting from the second light source diminishes lighting from the first light source when the first light source and second light source are simultaneously illuminated.

24. The indicator of claim 21, wherein the first vehicle characteristic has a greater priority of display than the second vehicle characteristic.

25. The indicator of claim 24, wherein lighting from the first light source diminishes lighting from the second light source when the first light source and second light source are simultaneously illuminated.

26. The indicator of claim 21, wherein the light pipe is transparent and positioned between the light box and first light source.

27. The indicator of claim 26, wherein the light pipe comprises a jagged surface shaped to distort light originating from the second light source towards the display screen.

28. The indicator of claim 21, wherein the display screen is a liquid crystal display and wherein the first and second light sources include at least one light-emitting diode.
